(19) United States
(12) Patent Application Publication
(10) Pub. No.: US 2007/0094862 A1
(43) Pub. Date: May 3, 2007

(54) Trimming an RFID antenna on a data disk

(76) Inventor: Joshua Posamentier, Oakland, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/266,048

(22) Filed: Nov. 2, 2005

(51) Int. Cl. H01Q 17/00; G08B 13/14

(52) U.S. Cl. 29/601; 340/572.7

(57) ABSTRACT

An ablating laser may be used to trim a metal-covered area on a data disk to form an antenna for an RFID tag that is on or in the data disk. In some embodiments the metal is aluminum that has been sputtered onto the disk.

### BACKGROUND

Radio frequency identification (RFID) technology has been employed on many different devices as a way of identifying objects without the need for direct human interaction or line-of-sight visibility. However, various types of devices, such as data disks, are still not good candidates for RFID because the cost of implementing an RFID antenna that is both durable and precise enough is too expensive compared to the cost of the disk itself. Although masks are sometimes used to deposit metal on data disks in pre-determined areas, such a mask does not lend itself to the fine geometry needed for an RFID antenna, and a mask process capable of producing such fine geometry may be too expensive to justify in this application.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a flow diagram of a process, according to an embodiment of the invention.

FIGS. 2A-F show a data disk as it is being manufactured with the process of FIG. 1, according to some embodiments of the invention.

FIG. 3 shows a flow diagram of a method of manufacturing, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

Within the context of this document, an RFID tag may be defined as comprising an RFID antenna (to receive an incoming signal that serves to query the RFID tag and to transmit a response in the form of a modulated radio frequency signal), and an RFID tag circuit (which may include circuitry to store an identification code for the RFID tag, circuitry to transmit that code through the antenna, and in some embodiments a power circuit to collect received energy from the incoming radio frequency signal and provide that energy to power the operations of the RFID tag circuit). As is known in the field of RFID technology, “transmitting” a signal from an RFID tag may include either: 1) providing sufficient power to the antenna to generate a signal that radiates out from the antenna, or 2) reflecting a modulated version of the received signal.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions stored on a machine-readable medium, which may be read and executed by a computing platform to perform the operations described herein. A machine-readable medium may include any mechanism for storing information in a from readable by a machine (e.g., a computer). For example, a machine-readable medium may include, but is not limited to, read only memory (ROM); random access memory (RAM); magnetic disk storage media; optical storage media; flash memory devices. A machine-readable medium may also include a tangible medium through which electrical, optical, acoustical or other form of propagated signals representing the instructions may pass, such as antennas, optical fibers, communications interfaces, and others.

Various embodiments of the invention may pertain to the fabrication of an RFID antenna on compact disk (CD), compact disk-read only memory (CD-ROM), digital video disk (DVD), or other similar optical disk that is used to store information in a machine-readable form. The fabrication of the antenna may involve the processes of metal deposition and subsequent trimming of the deposited metal.

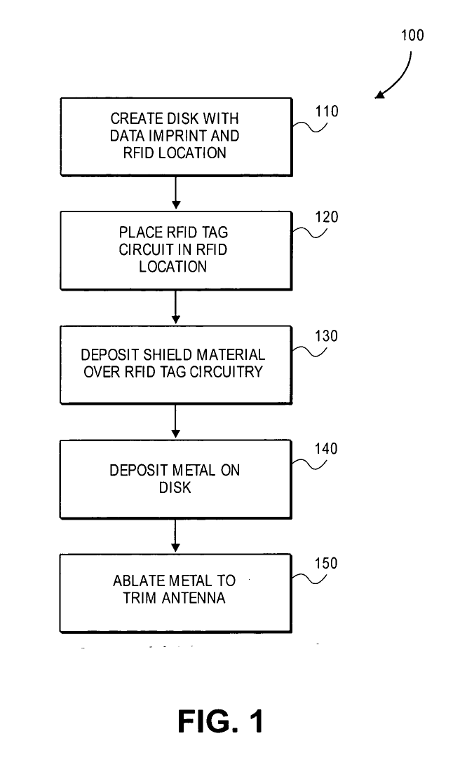

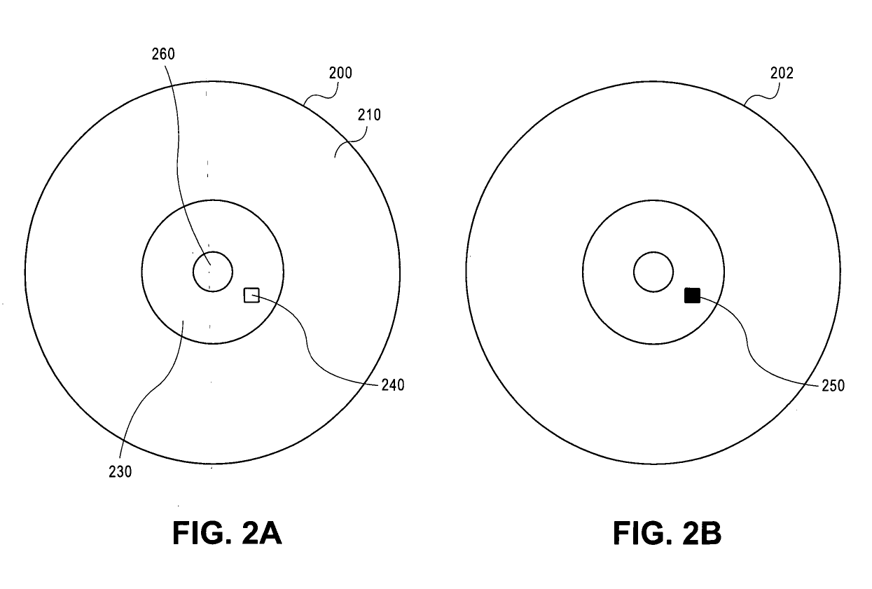

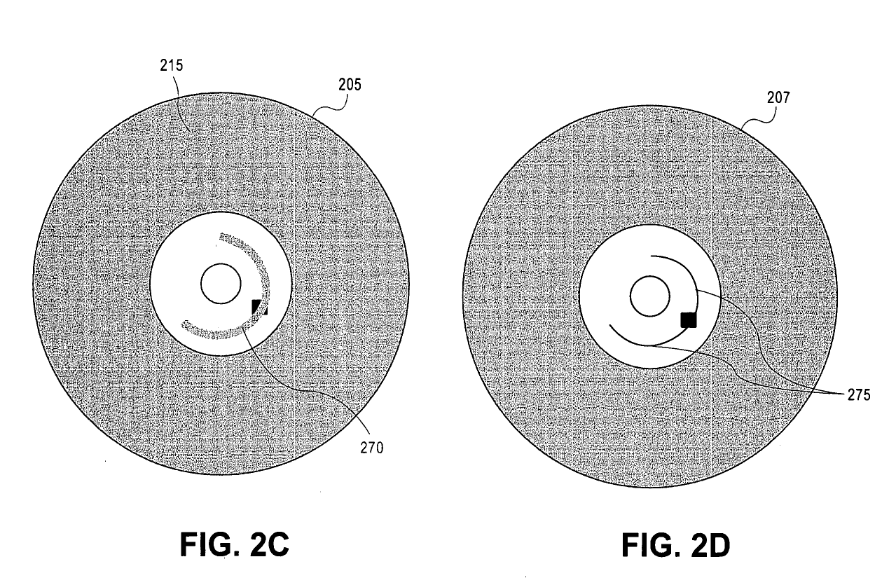

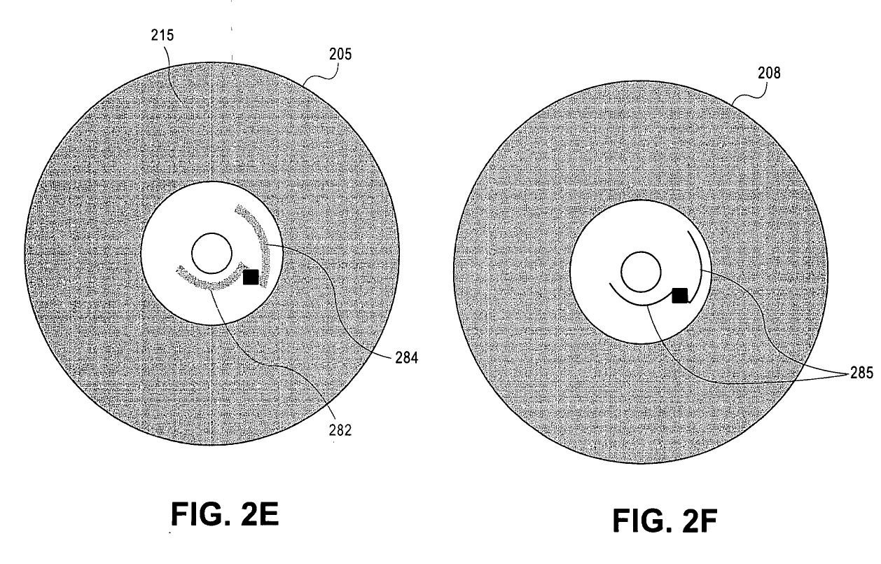

FIG. 1 shows a flow diagram of a process, according to an embodiment of the invention. FIGS. 2A-F show a data disk as it is being manufactured with the process of FIG. 1, according to some embodiments of the invention. FIGS. 2A, 2B, 2C and 2D describe the process to create a particular version of the final disk, while FIGS. 2A, 2B, 2E and 2F describe the process to create a different version of the final disk. To avoid unnecessary clutter in the figures, reference designators shown in one figure are generally not repeated in subsequent figures. For simplicity and ease of understanding, the process of FIG. 1 and the device shown in FIGS. 2A-F will be described together in the following paragraphs.

As shown at 110 of flow diagram 100 and in FIG. 2A, an unfinished data disk 200 may be created. In some embodiments the unfinished data disk 200 may already have been imprinted with data in unfinished data area 210, and a non-data area 230 near the center hole 260 may have an RFID tag location 240 configured to receive an RFID tag circuit. In some embodiments the location 240 may be a recess in the surface of unfinished data disk 200. Unfinished data disk 200 may be made of any feasible material, such as but not limited to polycarbonate, and may be formed in any feasible manner, such as but not limited to being injection molded and/or stamped. In some embodiments the unfinished data disk 200 may not contain any metal, although other embodiments may not be limited in this manner.

As shown at 120 of FIG. 1 and in FIG. 2B, an RFID tag circuit 250 may be placed within RFID tag location 240 to form an intermediate data disk 202. In some embodiments this placement may comprise attaching the RFID tag circuit 250 through any feasible means, such as but not limited to using adhesive and/or pouring a melted material into the recess at 240 and letting it solidify around tag circuit 250. In still other embodiments the RFID tag may be placed into the mold before liquid material is forced into the mold, and thus be embedded in the material when the data disk is first formed. This could combine the operations of FIG. 2A and FIG. 2B into a single operation, and could have the added advantage of permanently securing the RFID tag circuit so that it could not come loose and fly off later when the disk is spinning at high speed, as it might if only adhesive were used.

As shown at 130, a shield material may optionally be deposited over the RFID tag circuit in some embodiments. This shield material may serve multiple purposes, such as but not limited to: 1) it may be used to prevent a later application of metal from shorting out various internal circuitry in the RFID tag circuit, 2) it may be used to prevent a later removal of that metal from damaging that internal circuitry, and/or 3) it may be used to seal off the small RFIC tag circuit from contamination and/or the oxidizing effects of oxygen in the air. The antenna contacts (i.e., the electrical contacts on the RFID tag circuit to which the antenna element(s) will be connected) of the RFID tag circuit, however, should still be exposed through the shield material, either by removing the portion of the shield material that is directly over the contacts or by not placing the shield material over those contacts in the first place. For those embodiments in which the RFID tag circuit was originally molded into the interior of the data disk, the shield material may not be needed. Instead, another operation to remove the disk material from over the contacts may be needed.

As shown at 140 and in FIG. 2C, metal may be deposited on various parts of the data disk 202 to form a metalized data disk 205. The shaded areas show where metal may be deposited. This process may include metalizing (i.e., covering with metal) the data area to create the reflective characteristics that are needed by some data disk technologies that rely on optical sensors to read the data. Metalized data area 215 may be coated with any feasible metal, such as but not limited to aluminum, having the required reflective characteristics. In addition, metal may be deposited in the non-data area to form an antenna blank 270 which covers and directly touches the antenna contacts of the RFID tag circuit. The metal of antenna blank 270 may be any feasible metal or other material that is electrically conductive, such as but not limited to aluminum. In some embodiments the data area and the antenna blank area may use the same type of metal, which may simplify manufacturing operations and reduce cost. If metal is deposited over the circuitry area of the RFID tag circuit, the non-conductive shield material of operation 130 may be used to prevent the deposited metal from touching that circuitry.

The method of depositing the metal may be any feasible method, such as but not limited to sputtering. To control where the metal is deposited, in some embodiments a mask may be used to block off portions of the data disk and prevent metal from being deposited in those areas. In some embodiments the metalized data area and the metalized antenna blank are on opposite sides of the disk. In other embodiments the metalized data area and the metalized antenna blank are on the same side of the disk, which may simplify manufacturing operations and reduce cost.

Although a mask may be used to prevent metal from being deposited on certain areas of the disk, a masked sputtering operation may not lend itself to creating accurate metal features on the disk. Therefore, a more precisely controlled removal process may be used to trim the antenna blank into an accurately formed antenna. As shown at 150 and in FIG. 2D, a controlled process may be used to trim the metal in the antenna blank, so that the metal that remains will have the desired shape, location, and dimensions of an RFID antenna. In some embodiments a tightly-controlled laser, such as but not limited to a YAG or CO₂ laser, may be used to ablate the unwanted metal in the antenna blank. Since many RFID tags use a dipole antenna, with two sections that are electrically isolated from each other, the metal over portions of the RFID tag circuit may be completely removed, leaving two sections of the antenna that each contact one of the antenna contacts in the RFID tag circuit, but do not contact each other. Since a laser that ablates metal may damage exposed parts of the circuitry in the RFID tag circuit after the overlying metal has been removed, the protective material of operation 130 may be used to prevent such damage. The shield material may have reflective characteristics that reflect most of the laser beam so that the underlying circuitry is protected from the energy of that laser beam.

The antenna blank 270 and the finished antenna sections 275 are shown following a circular pattern concentric to the center axis of the data disk. This pattern permits the ablation laser to be positioned over the disk and moved only slightly, in a radial direction, while the disk rotates beneath it. However, other techniques may be used to create antenna sections with other shapes.

FIGS. 2E and 2F show similar embodiments, with a slightly different pattern for the antenna sections. As shown at 140 and in FIG. 2E, metal may be deposited on disk 205 in the general area of the eventual antenna to form antenna blanks 282 and 284, as well as being deposited in data area 215. Portions of the deposited metal may then be removed through laser ablation to leave antenna 285 on completed disk 208. The primary difference between the process of FIGS. 2C,2D and the process of FIGS. 2E,2F is that the antenna blanks of FIG. 2E are positioned so that they may contact the antenna contacts at the innermost and outermost (when measured radially) corners of the RFID tag circuit and do not pass over the sensitive central circuit area of the RFID tag circuit. Therefore, the laser may not need to ablate metal from over that sensitive circuit area, and the requirement for shield material may be lessened or even eliminated. Although the example shows the antenna blanks ending approximately at the antenna contacts, in other embodiments they may extend past those antenna contacts.

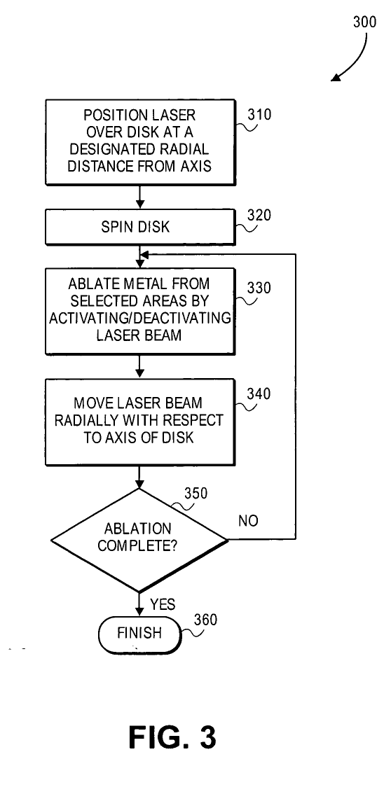

FIG. 3 shows a flow diagram of a method of manufacturing, according to an embodiment of the invention. In flow diagram 300, at 310 a laser may be positioned over a data disk which has had metal deposited on it approximately in the intended location of an RFID antenna. At 320 the disk may be spun about its axis at a speed suitable for an ablation operation. At 330 the laser beam may be turned on to ablate any portion of the deposited metal that passes through the laser beam. In addition to ablating metal in this manner at a designated radial distance from the axis, the laser beam may be turned on and off at designated times so that it does not ablate any metal from particular locations, even if those locations are at the designated radial distance. Further, the laser beam may be turned off when non-metalized portions of the data disk are passing through the laser beam.

After ablating metal from selected locations at the designated radial distance, the laser beam may be moved radially so that the laser beam will strike the data disk at a different radial distance. Such movement may be performed in any feasible manner, such as but not limited to: 1) moving the laser device, 2) rotating the laser device so that the beam strikes the disk at a different radial distance, 3) redirecting the laser beam with a movable mirror so that the laser beam strikes the disk at a different radial distance, 4) etc. Operations 330 and 340 may be repeated at different radial distances until the portions of the deposited metal that remain form an RFID antenna on the surface of the data disk. These operations may include removing deposited metal from above a circuit area of an RFID tag circuit that is in or on the data disk. After removing metal from the desired areas, ablation may be considered complete at 350, and any remaining finishing operations may be performed at 360, such as removing the data disk from the manufacturing apparatus.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. A method, comprising:
depositing a conductive material onto a data disk in an area to be used for a radio frequency identification (RFID) antenna; and
removing a portion of the deposited metal to produce the RFID antenna.

2. The method of claim 1, wherein said depositing a conductive material comprises a sputtering process.

3. The method of claim 1, wherein the conductive material comprises aluminum.

4. The method of claim 1, wherein said removing comprises ablating the portion of the deposited metal.

5. The method of claim 4, wherein said ablating comprises using a laser beam to trim away the portion of the deposited metal.

6. The method of claim 4, wherein said ablating comprises using at least one of a YAG laser or a CO₂ laser to trim away the portion of the deposited metal.

7. The method of claim 1, further comprising attaching an RFID tag circuit to the data disk prior to said depositing a conductive material.

8. The method of claim 1, further comprising molding an RFID tag circuit into the data disk prior to said depositing a conductive material.

9. The method of claim 1, further comprising depositing a layer of shield material over a portion of the RFID tag prior to said depositing a conductive material.

10. The method of claim 1, wherein said depositing comprises depositing a same type of metal as is deposited over a data area of the disk.

11. The method of claim 1, where said depositing comprises masking an area of the data disk to prevent depositing the metal on the masked area.

12. The method of claim 1, wherein said depositing comprises depositing on a side of the disk that includes a data area.

13. An apparatus, comprising a data disk having a radio frequency identification (RFID) antenna formed of laser-trimmed deposited metal.

14. The apparatus of claim 13, further comprising an RFID tag circuit coupled to the RFID antenna.

15. The apparatus of claim 13, wherein the laser-trimmed deposited metal comprises laser-trimmed aluminum.

16. The apparatus of claim 13, wherein the laser-trimmed deposited metal comprises sputtered metal.

17. An article comprising
a machine-readable medium that provides instructions, which when executed by a computing platform, result in at least one machine performing operations comprising:
spinning a data disk;
activating a laser pointed at a portion of the data disk; and
moving the laser radially to ablate at least one portion of metal on the data disk to form a radio frequency identification (RFID) antenna on the data disk.

18. The article of claim 17, wherein the operations further comprise turning a beam from the laser on and off at selected locations on the data disk.

19. The article of claim 17, wherein the operations of spinning, activating, and moving are controlled to remove the metal from over a circuit area of a radio frequency identification (RFID) tag circuit.
